(19) United States
(12) Patent Application Publication
(10) Pub. No.: US 2015/0051864 A1
(43) Pub. Date: Feb. 19, 2015

(54) Device and Method for Determining Particle Size Distribution On-line Using Acoustic Spectroscopy Through a Pipe

(71) Applicant: Andrei S. Dukhin, Goldens Bridge, NY (US)

(72) Inventor: Andrei S. Dukhin, Goldens Bridge, NY (US)

(21) Appl. No.: 14/462,718

(22) Filed: Aug. 19, 2014

Related U.S. Application Data
(60) Provisional application No. 61/867,361, filed on Aug. 19, 2013.

(51) Int. Cl. G01N 29/036; G01N 29/46; G01N 15/02

(52) U.S. Cl. CPC G01N 29/036; G01N 15/02; G01N 29/46; G01N 2291/02416; G01N 2291/014
USPC 702/128

(57) ABSTRACT

A device for determining particle size distribution on-line for concentrated dispersions or emulsions. The device includes an electronic block for generating electric pulses of specified frequencies on MHz scale and measuring magnitude and phase thereof. An acoustic sensor has an ultrasound transmitter to convert the electric pulses into ultrasound pulses of a same frequency and an ultrasound receiver to convert the ultrasound pulses back into electric pulses. The transmitter and the receiver each have a respective face. A stepping motor is connected to a movable piston, which carries one of the ultrasound transmitter or the ultrasound receiver thereon. A pipe with a flexible wall to conduct the dispersion or emulsion past the acoustic sensor. The pipe is disposed between the transmitter and the receiver, and the pipe has an exterior surface. The face of the transmitter and the face of the receiver are affixed to the exterior surface of the pipe.

### CROSS-REFERENCE TO RELATED APPLICATION

This application claims the benefit and priority of U.S. Provisional Patent Application Ser. No. 61/867,361 filed Aug. 19, 2013, entitled Device and Method for Determining Particle Size Distribution On-line Using “Acoustic Spectroscopy Through Wall;” the prior application is herewith incorporated by reference in its entirety.

### BACKGROUND OF THE INVENTION

1. Field of the Invention

Characterization of particle size distribution.

2. Description of the Related Art

Acoustic spectroscopy is a well known method for determining distribution of sizes for particles that are dispersed in liquids. There is International Standard 20998 “Measurement and characterization of particles by acoustic methods” [1]. There is a recent book published by Dukhin A. S. and Goetz P. J in 2010 “Characterization of liquids, nano- and microparticulates and porous bodies using Ultrasound” [2] presenting achievements on this field. There are several US Patents on this subject as well: U.S. Pat. No. 4,412,451 (1983), U.S. Pat. No. 4,509,360 (1985), U.S. Pat. No. 4,706,509 (1987), U.S. Pat. No. 5,121,629 (1992), U.S. Pat. No. 5,359,897 (1994), U.S. Pat. No. 5,368,716 (1994), U.S. Pat. No. 5,569,844 (1996), U.S. Pat. No. 5,951,163 (1999), U.S. Pat. No. 6,109,098 (2000), U.S. Pat. No. 6,119,510 (2000), U.S. Pat. No. 6,449,563 (2002), U.S. Pat. No. 6,604,408 (2003), U.S. Pat. No. 7,114,375, (2006), U.S. Pat. No. 7,331,233 (2008) and U.S. Pat. No. 7,984,642 (2011).

Acoustic spectroscopy yields information on two fundamental properties of the sample: sound speed and attenuation coefficient. There is a consensus of opinions reflected in ISO Standard 20998 that measurement of ultrasound attenuation frequency dependence in the MHz range yields the most information for determining particle size distribution in concentrated dispersions and emulsions. The present invention provides improvements in measuring ultrasound attenuation frequency spectra during on-line usage of the sample. Calculation of the particle size distribution from the measured attenuation spectra is assumed to be conducted following algorithms presented in the book by Dukhin and Goetz [2].

There are several different approaches suggested in the above-mentioned patents for conducting measurement of the ultrasound attenuation. Most of the patents have been developed for laboratory devices. However, it is well recognized on the field that Acoustic spectroscopy is desirable for on-line characterization of complex heterogeneous dispersions and emulsions because they do not require dilution. Acoustic spectroscopy can be applied for characterizing opaque systems as is. Therefore, On-line process characterization is the ultimate goal of the present invention. An on-line process characterization is a process characterization where the sample flows continuously through the measuring device, which is attached either to the production line or to a bypass for such line.

There are several U.S. patents that target on-line characterization using ultrasound. For instance, U.S. Pat. No. 5,359,897 1994 to Hamstead discloses measuring sound speed across a pipe by “ . . . flat members seal apertures in the pipe and two transducers are attached to respective flat members . . . ”. U.S. Pat. No. 5,951,163, to Cao et al., discloses using ultrasound for characterizing castings and molding by “ . . . ultrasonic transducers made of high Curie temperature materials, fabricated by sol-gel techniques and directly deposited on top of the ultrasonic waveguides or the external walls of the shot sleeve of the die caster, die of the die caster, mold of the injection molding machine or barrel of the extruder are also used.”

The above and other similar inventions disclose placing either one or two transducers in contact with the pipe that supports a stream of the liquid sample that is being characterized. In the case of single transducer, the transducer serves as transmitter and then as a receiver of the reflected signal. In case of a pair of transducers, one serves as a transmitter and the other one is a receiver.

There are embodiments where transducers protrude through the pipe wall and come into direct contact with the liquid sample. There are other embodiments where transducers are attached to the exterior surfaces of the pipe.

In all cases, the position of the transducers is fixed. However, applicant has discovered that this is the point where significant improvements in the on-line characterization method can be achieved.

A fixed position of transducers creates two problems for a precise and accurate attenuation measurement.

The first problem is related to unknown energy losses in the transducers themselves and in the associated electronics. This so-called “hardware energy loss” is a part of the “total energy loss” that is usually measured in transmission type instruments. The hardware energy loss must be subtracted from the “total energy loss” for calculating “sample energy loss”, which is the source for calculating the attenuation coefficient α, of the studied liquid sample.

In the prior art, calibration with a material having a known attenuation coefficient is required for determining “hardware energy loss”. This complicates the method significantly. It means that before starting on-line characterization, calibration liquid material must be pumped through the system. In many cases, this is very hard to implement. This is especially the case when sterilization is required.

The second problem is related to an unknown value of the optimum gap between the transmitter and the receiver. This parameter is critical for successful measurement and it is very much dependent on the nature of the complex liquid being tested. For instance, if the liquid attenuates ultrasound strongly, then a measurement can only be conducted for rather small gaps between the transmitter and the receiver. Ultrasound does not penetrate through larger gaps of such materials. On the other hand, if the gaps are too small, then ultrasound is not affected by the liquid at all. Consequently, such measurements provide no information about the liquid.

In this regard, applicant points out that an optimum value of the gap between the transmitter and the receiver is frequency dependent because attenuation of the complex liquid strongly depends on frequency. This means, that a fixed gap restricts ability to conduct measurement over a wide frequency range. This, in turn, limits the amount of raw data for calculating particle size distribution.

Development of acoustic spectroscopy devices according to the present invention leads to solutions for these two problems. It is shown in the book by Dukhin and Goetz [2] that there are two essential features that make acoustic attenuation measurement absolute (requiring no calibration) and universal for a wide range of complex liquids. These are pulse signal processing and a movable gap between transmitter and receiver. In the instant application, a way of implementing moving gap techniques for on-line characterization is set forth.

A moving gap offers simple resolution of the first problem mentioned above, namely direct measurement of the “hardware energy loss”. It can be achieved at the beginning of the measurement cycle by putting transmitter and receiver in contact with each other. Propagation of ultrasound pulses through such a configuration depends on the acoustic properties of the transmitter and receiver. Thus, the measured energy loss is the unknown “hardware energy loss”. Accordingly, a calibration is not required for determining this parameter.

After this preliminary step is finished, the distance between transmitter and receiver begins to vary in steps. The variable gap method makes possible application of the Beer-Lambert law [3, 4] that relates the energy launched into the system (I₀) with transmitted part (Iₓ) after propagating distance X:

Iₓ=I₀l^{-αX} (1)

where α is the attenuation coefficient per unit length. This is an intensive parameter of the system in similar fashion to density, viscosity, sound speed, etc. The attenuation coefficient can be predicted theoretically as a function of particle size distribution and a few input parameters; thus is the reason why the attenuation coefficient must be the main output of the experimental procedure.

Equation 1 can be re-written as the following:

$$α X = ln \frac{{I}_{0}}{{I}_{x}} \qquad ( 2 )$$

This means that the ratio of ultrasound intensities measured at different gaps between the transmitter and receiver—and expressed in decibels (logarithm on decimal basis)—should be a linear function of the gap. This conclusion is easily verifiable experimentally. It can serve as a test indicating the reliability of the particular measurement.

The method of the present invention eliminates calibration because instead of absolute energy, the acoustic sensor measures rate of energy loss.

Another important advantage of the method is low sensitivity to contamination of transducers surfaces. Concentrated samples could potentially build up deposits on the transducer's surfaces. The deposits of particles would affect absolute acoustic energy, but not the rate of its decay during pulse propagation through the sample.

On the other hand, the moving gap creates some complications for an on-line process. Hydrodynamic resistance becomes variable in time. A transducer protruding into the pipe could cause clogging. These factors are and have been a strong deterrent to a method for on-line characterization.

Applicant has discovered a modification that can resolve, or at least minimize such problems. To this end, the present invention provides for attaching a transmitter and a receiver of an ultrasound transducer to a “flexible pipe”, on an external surface thereof. Here, the term “flexible” is the ability of the pipe wall to be displaceable by moving the transducers such that sections of the inner wall at the oppositely connected transmitter and receiver can be displaced towards one another and brought into contact with one another without substantially varying the wall thickness of the flexible pipe at the location of the transmitter and receiver. The deflection must be reversible so that the flexible pipe can be restored to the initial geometry when the transmitter and receiver open the gap between one another. The pipe must withstand a number of such displacements required for the number of the particle size measurements required for at least one complete on-line characterization test. The flexible tube is a replaceable item, which can be provided in quantity and in sterile form when necessary. The modifications bring substantial advantages.

First of all, “hardware energy loss” is determined by moving the gap to the point where internal surfaces of the flexible pipe touch each other. Therefore, the “hardware energy loss” automatically includes “energy loss in the walls of the pipe”.

The flexible pipe allows for opening the gap between transmitter and receiver in increments and verifies the validity of Beer-Lambert law for sound propagating through the sample. The same law can be used for calculating the attenuation coefficient.

Changing the gap between the transmitter and the receiver allows a determination of the optimum gap range for a particular sample.

Having the sample travel through the flexible pipe eliminates contamination of the transmitter and receiver interfaces.

The sample can easily be pumped along the pipe because obstruction to hydrodynamic flow is minimized in the flexible pipe as compared to a rigid pipe and a transducer protruding inside the pipe.

The pipe can be sterilized with high temperature treatment before the acoustic sensor is connected to it from outside.

Chemically aggressive substances can be measured by being placed inside of chemically resistant flexible pipes.

### SUMMARY OF INVENTION

The instant application describes a device and method for characterizing particle size distribution of concentrated dispersions and emulsions on-line by measuring ultrasound attenuation frequency spectrum and then calculating particle size distribution using existing theoretical models. For measuring attenuation frequency spectrum the instant application discloses to connect the ultrasound transmitter and the ultrasound receiver to external surfaces of the flexible pipe, opposite one another. The flexible pipe allows pumping of the sample past the sensor without direct contact between the transmitter and the receiver. The fact that the pipe is flexible allows for a moving gap method and allows for measurement of the acoustic energy loss in the hardware, instead of requiring the complex calibration. In order to take advantage of all benefits associated with movable gap method, either the transmitter or the receiver is placed inside of a piston that is connected to a stepping motor. The motor changes a relative distance between transmitter and receiver in incremental steps, and may even bring opposite sides of the wall of the flexible pipe into contact. An electronic block functioning in pulse mode generates electric pulses of a certain frequency. The ultrasound transmitter converts the electric pulses into ultrasound pulses of the same frequency. The pulses propagate through the wall of the flexible pipe and attenuate somewhat. Then, leftover pulses propagate thought the flow of the complex liquid being studied and attenuate even more. Then the pulses come to the opposite wall of the flexible pipe and attenuate further. Finally, the ultrasound receiver converts them back into electric pulses and sends the pulses to electronic block for comparison. The procedure is repeated for a given gap at a given frequency for multiple pulses until a signal to noise ratio reaches a specified target value. In order to extract the degree of attenuation only in the liquid flow, the energy loss in hardware, including in the flexible pipe walls, is measured when stepping motor establishes a gap position when the internal surface of the flexible pipe comes into contact with itself.

The attenuation coefficient of the dispersion or emulsion is calculated using Beer-Lambert law for multiple gap positions between the transmitter and the receiver. Alternatively, the measurement can be conducted at a single optimum gap, the value of which is determined by a preliminary multiple gap measurement.

This application describes a device and method for measuring ultrasound attenuation frequency spectrum on-line. This experimental raw data then serves as source of information for calculating particle size distribution using existing theoretical models. For measuring attenuation frequency spectrum we suggest to connect ultrasound transmitter and ultrasound receiver to external surfaces of the flexible pipe, one opposite to the other. This pipe allows pumping of the sample through the sensor without direct contact between transmitter and receiver. The fact that it is flexible allows for moving gap method and measurement of the acoustic energy loss in the hardware, instead of calibrating it off. In order to take advantage of all benefits associated with movable gap method that either the transmitter or the receiver is placed inside of the piston that is connected to the stepping motor. Applicant suggests the motor can change relative distance between transmitter and receiver in incremental steps, and even bring them in contact. The electronic block functioning in pulse mode generates electric pulses of a certain frequency. The ultrasound transmitter converts these electric pulses into ultrasound pulses of the same frequency. These pulses propagate through the wall of the flexible pipe and attenuate somewhat. Then, leftover pulse propagate thought the flow of the complex liquid being studied and attenuate even more. Then it comes to the opposite wall of the flexible pipe and attenuates further. Finally, the ultrasound receiver converts them back into electric pulses and sends the pulses to the electronic block for comparison. This procedure is repeated for a given gap at a given frequency for multiple pulses until signal to noise ratio reaches specified target value. In order to extract degree of attenuation in the liquid flow only, the energy loss in hardware, including flexible pipe walls, is measured when stepping motor establishes gap position when opposite sections of an internal surface of the flexible pipe come into contact. Attenuation coefficient of the dispersion or emulsion is calculated using Beer-Lambert law for multiple gap positions between transmitter and receiver. Alternatively, measurement can be conducted at a single optimum gap, a value of which is determined by preliminary multiple gaps measurement.

With the foregoing and other objects in view there is provided, in accordance with the invention a device for determining particle size distribution on-line for concentrated dispersions or emulsions. The device includes an electronic block for generating electric pulses of specified frequencies on MHz scale and measuring magnitude and phase thereof. An acoustic sensor has an ultrasound transmitter to convert the electric pulses into ultrasound pulses of a same frequency and an ultrasound receiver to convert the ultrasound pulses back into electric pulses. The transmitter and the receiver each have a respective face. A stepping motor is connected to a movable piston, which carries one of the ultrasound transmitter or the ultrasound receiver thereon. A pipe with a flexible wall to conduct the dispersion or emulsion past the acoustic sensor. The pipe is disposed between the transmitter and the receiver, and the pipe has an exterior surface. The face of the transmitter and the face of the receiver are affixed to the exterior surface of the pipe.

In accordance with another advantageous and thus preferred feature of the device, the exterior surface of said pipe is affixed to said face of said receiver and to said face of said transmitter so that said faces and said surface do not move relative to one another during compression of said pipe.

With the foregoing and other objects in view there is also provided, in accordance with the invention a method for determining particle size distribution on-line for concentrated dispersions and emulsions. The method includes driving the stepping motor to a point where a distance between the transmitter and the receiver faces equals twice a thickness of the pipe wall for defining a closed system. Subsequent to defining the closed system, transmitting pulses at the specified frequencies through the closed system for measuring a first energy loss of the transmitter, the receiver, and the pipe at each of the specified frequencies. Moving a sample through the pipe and driving the stepping motor in specified multiple increments for opening the pipe to gap positions between the transmitter and the receiver and transmitting the pulses at the specified frequencies for each of the gap positions for measuring a second energy loss at each of the specified frequencies. For each of the specified frequencies, subtracting the first energy loss from the second energy loss at the corresponding frequencies for each of the gap positions for determining energy losses in the sample. Presenting the energy losses in the sample in decibels. For each of the gap positions, generating measured attenuation frequency spectra by calculating measured attenuation for each of the specified frequencies as a result of linear regression of the energy loss versus a value of a corresponding gap position between the transmitter and the receiver. Determining particle size distribution as a result of best theoretical fit of the measured attenuation frequency spectra.

With the foregoing and other objects in view there is additionally provided, in accordance with the invention a method for determining particle size distribution on-line for concentrated dispersions and emulsions. The method including driving the stepping motor to a point where a distance between the transmitter and the receiver faces equals twice a thickness of the pipe wall for defining a closed system. Subsequent to defining the closed system, transmitting pulses at the specified frequencies through the closed system for measuring a first energy loss of the transmitter, the receiver, and the pipe at each of the specified frequencies. Moving a sample through the pipe and driving the stepping motor in specified multiple increments for opening the pipe to gap positions between the transmitter and the receiver and transmitting the pulses at the specified frequencies for each of the gap positions for measuring a second energy loss at each of the specified frequencies. For each of the specified frequencies, subtracting the first energy loss from the second energy loss at the corresponding frequencies for each of the gap positions for determining energy losses in the sample. Defining an optimum single gap position by selecting a gap position of the gap positions that allows measurement at the widest frequency range. Driving the stepping motor for opening the transmitter and the receiver to the optimum single gap. Moving the sample through the pipe and transmitting the pulses at the specified frequencies at the optimum single gap position for measuring a third energy loss at each of the specified frequencies. For each of the specified frequencies, subtracting the first energy loss from the third energy loss at the corresponding frequencies for the optimum single gap position for determining single optimum gap position energy loss in the sample. Presenting the single optimum gap position energy loss in the sample in decibels. For the optimum single gap position, generating measured attenuation frequency spectra by calculating measured attenuation for each of the specified frequencies as a result of linear regression of the single optimum gap position energy loss versus a value of the optimum single gap position between the transmitter and the receiver. Determining particle size distribution as a result of best theoretical fit of the measured attenuation frequency spectra.

With the foregoing and other objects in view there is yet further provided in accordance with the invention a device for determining particle size distribution on-line for concentrated dispersions or emulsions. The device includes an acoustic sensor has an ultrasound transmitter to convert electric pulses into ultrasound pulses of a same frequency and an ultrasound receiver to convert the ultrasound pulses back into electric pulses. The transmitter and said receiver each having a respective face. A pipe has a flexible wall conducts the dispersion or emulsion past the acoustic sensor. The pipe is disposed between said transmitter and said receiver, and said pipe has an exterior surface, said face of said transmitter and said face of said receiver are affixed to said exterior surface of said pipe for compressing the pipe therebetween.

In accordance with an added feature of the device, a displacing device is mounted to one of said ultrasound transducer or said ultrasound receiver to displace said flexible wall to selectable gap positions.

In accordance with yet another added feature of the device, an electronic block connects to said acoustic sensor for generating electric pulses of specified frequencies on MHz scale and measuring magnitude and phase thereof.

### BRIEF DESCRIPTION OF THE DRAWINGS

FIG. 1. is a schematic diagram including components for determining particle size distribution;

FIGS. 2a. and 2b. are diagrams of the flexible pipe between the acoustic transmitter and receiver, with the pipe collapsed when gap between them is closed or separated by thin layer of liquid, and expanded when the gap is open;

FIG. 3. shows particle size distribution of the alumina dispersion selected for the method verification;

FIG. 4. shows attenuation spectra measured for the 5% wt alumina dispersion placed inside of the flexible pipe with 1.55 mm wall thickness. A set of frequencies includes 18 frequencies from 3 to 20 MHz. A set of gaps includes 21 gaps from 0.3 to 8 mm. Green curve corresponds to theoretical attenuation calculated for the particle size distribution shown on FIG. 3;

FIG. 5. shows acoustic energy loss in the hardware, which includes losses to the electric-acoustic energy conversion in the transmitter and the receiver, and the loss in the walls of the flexible pipe;

FIG. 6. shows loss of acoustic energy in the sample at various frequencies as the function of the gap between the transmitter and the receiver. The linear dependence confirms that Beer-Lambert law holds for the suggested setup and can be used for calculating attenuation coefficient.

### DETAILED DESCRIPTION OF INVENTION

The device 1 for on-line measuring particle size distribution in liquids includes the electronic block 2 and acoustic sensor 3. The electronic block 2 of the device can generate short electric pulses with different frequencies from 1 to 100 MHz and can measure their magnitude and phase. The electronic block 2 sends the pulses to the acoustic sensor 3 and then measures the pulses after they have propagated through the sensor 3. The electronic block 2 can be embodied as disclosed in Chapter 7 section 7.4.2 of Dukhin A. S. and Goetz P. J in 2010 “Characterization of liquids, nano- and microparticulates and porous bodies using Ultrasound” published by Elsevier.

The acoustic sensor 3 contains two ultrasound transducers 3a, 3b that can convert electric pulses into ultrasound pulses of the same frequency, and vise versa. One of the transducers 3a, 3b serves as a transmitter of the ultrasound pulses and the other one is a receiver. One of the transducers is placed inside of a piston 4 that is connected to a stepping motor 5. The stepping motor 5 moves one transducer relative to the other and, consequently, changes the distance (gap) there between.

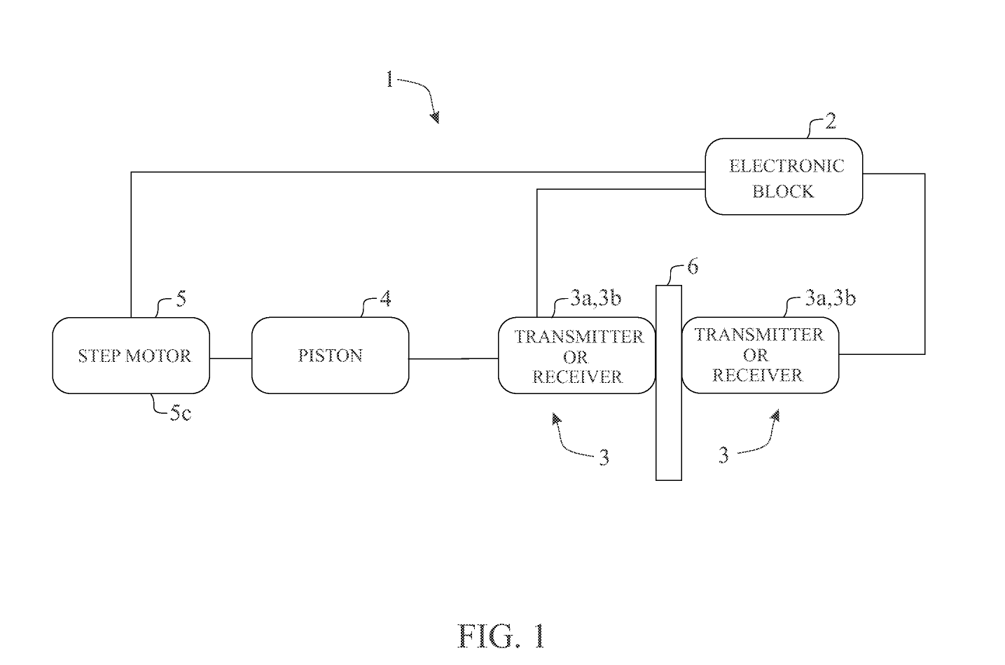

A flexible pipe 6 is inserted in the gap between the transmitter and the receiver, as shown on FIG. 1. The flexible pipe 6 serves as a conduit for pumping concentrated dispersion or emulsion past the acoustic sensor 3. An exterior surface of the pipe 6 is connected to the faces of both of the transmitter and the receiver 3a, 3b. The connection must prevent any sliding of the pipe surface relative to faces of the transducers. Such can be achieved by using glue. The pipe 6 may have a cross-section that is not round.

The transmitting transducer 3a, 3b converts electric pulse generated by the electronic block 2 into the ultrasound pulses of the same frequency.

The ultrasound pulses propagate through a wall 6a of the flexible pipe 6 and attenuate somewhat.

Then, the leftover pulses propagate through a liquid sample LS inside of the pipe 6. The pulses interact with the liquid LS and particles of the liquid sample LS, and consequently attenuate.

Then, the leftover pulses propagate again though the opposite section of the flexible pipe wall 6a and attenuate more.

Finally, the leftover pulses reach the second transducer (receiver) 3a, 3b, which converts the received ultrasound pulses back into electric pulses.

Comparison of the initial and final electric pulses yields information on the total amount of energy that is lost in the acoustic sensor 3 and in the liquid sample LS.

The “total energy loss” contains several additive terms of loss. The first term is the energy loss in transducers 3a, 3b and flexible pipe wall 6a, which as noted above, is the “hardware energy loss”. The second term is “sample energy loss”, which is the purpose of this measurement.

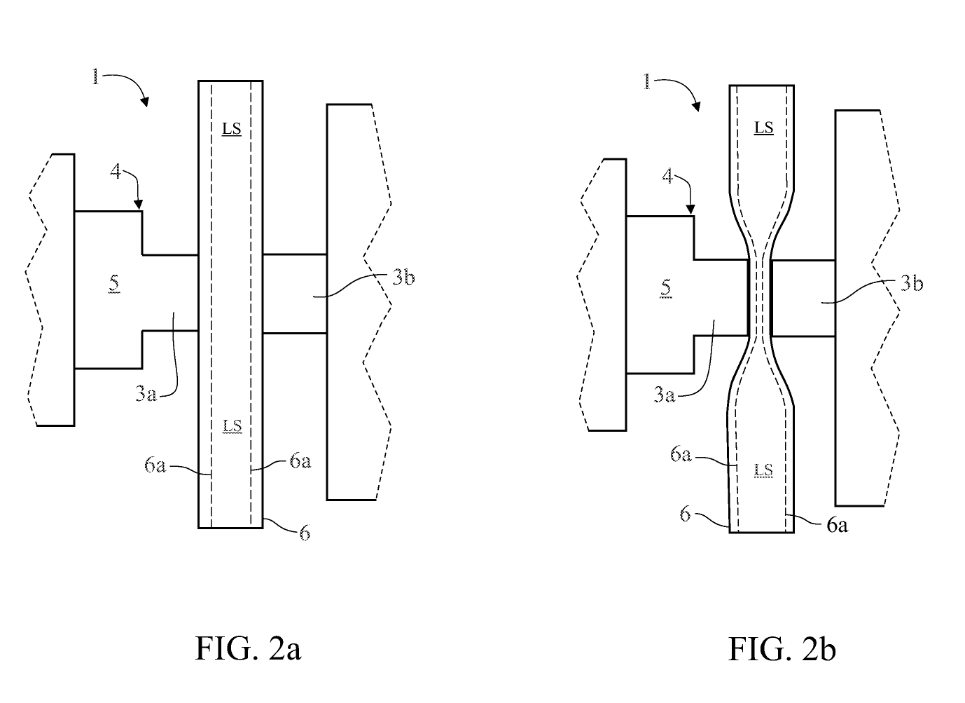

In order to obtain “sample energy loss” from the “total energy loss”, the “hardware energy loss” is required. In order to determine the unknown parameter, software in the electronic block directs a motor controller 5c to drive stepping motor 5 to the position where liquid is squeezed away from the gap between transducers 3a, 3b, as is shown in FIG. 2. Here, the wall 6a of the flexible pipe 6 comes into contact with itself, or is separated by very thin layer of liquid at this position. Transmission of ultrasound pulses through such a closed system reveals amount of energy lost in hardware. The preliminary measurement must be conducted for all frequencies of the selected frequency set.

Subsequently, the stepping motor 5 begins opening gap in increments between the transmitter and the receiver 3a, 3b according to a certain scenario defined at the beginning of the experiment. This set can contain either single gap or certain number of multiple gaps from certain minimum to certain maximum value. In some occasions, it might be convenient initially to open gap to its maximum value and then close it in increments.

Transmission of pulses at these gaps reveals “total energy loss” at particular frequencies and gaps. After the measurement is finished for all specified gaps and frequencies, software subtracts “hardware energy loss”. This yields the value of “sample energy loss” for each gap and each frequency.

In order to extract the attenuation coefficient α from the “sample energy loss” software in the electronic block 2 applies Beer-Lambert law that relates energy launched into the sample (I₀) with transmitted part (Iₓ) after propagating distance X.

Iₓ=I₀l^{-αX}

The distance is equal to the particular gap value between the transmitter and the receiver 3a, 3b.

The method of using multiple gaps allows a determination of the optimum gap between the transmitter and the receiver that yields most information about studied sample attenuation. Existence of such an optimum gap follows from the fact that highly attenuating samples do not allow any pulses going through at a relatively wide range, whereas low attenuating sample do not attenuate at all at through the short gaps. A value of the optimum gap for particular dispersion or emulsion can be derived from the multiple gap measurement. The optimum gap can be defined as such that allows measurement at the widest frequency range, which would make attenuation to become the most sensitive to the particle size.

A single gap mode is desirable for minimizing variation of the hydrodynamic resistance to the flow through the flexible pipe 6. The single gap mode does not require preliminary step of the hardware energy loss for every measurement. Instead, this parameter can be measured just once, at the beginning of the test. This opens possibility to conduct measurements at a constant hydrodynamic flow through the pipe 6, with no variation in hydrodynamic resistance.

The attenuation coefficient depends on the frequency and particles size distribution. Measured frequency dependence allows extraction of information on the particle size distribution using standard best theoretical fit method, which employs theoretical models presented in the book by Dukhin and Goetz, (2010).

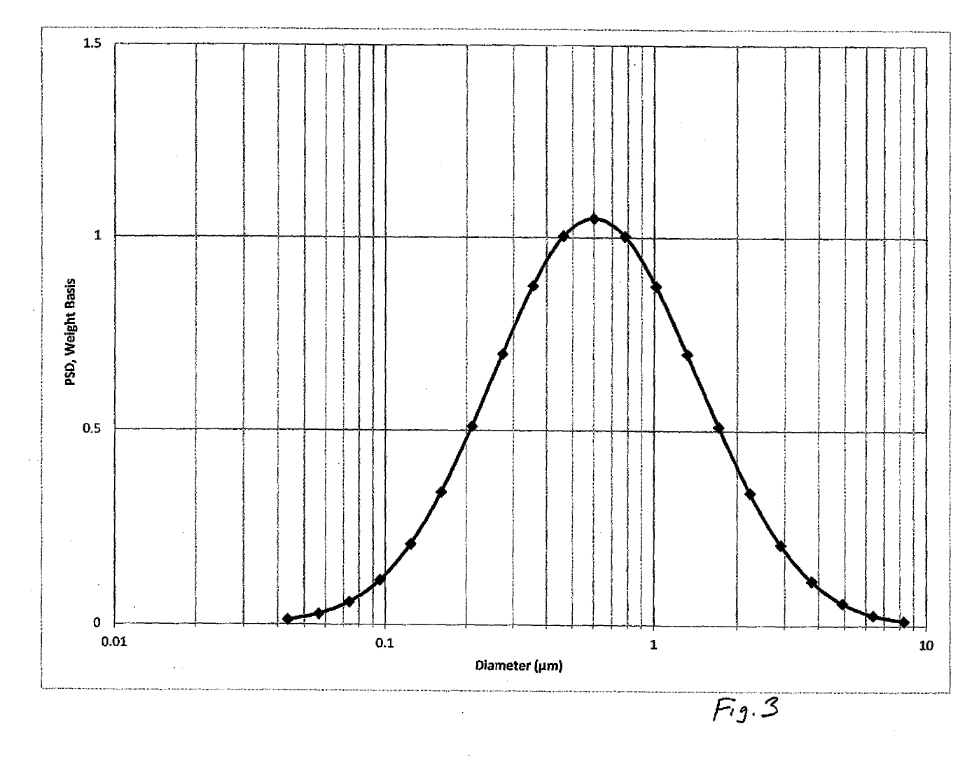

Example A: The device was tested using a dispersion at 5% wt of alumina particles with reported median particle size 0.6 microns in water at pH=4. Particle size distribution of this dispersion was measured independently with Acoustic Spectrometer DT-100 from Dispersion Technology Inc., shown in FIG. 3. The system is very stable at this pH due to high surface charge of alumina particles.

The dispersion liquid sample LS was poured into the flexible pipe 6 in FIGS. 1 and 2.

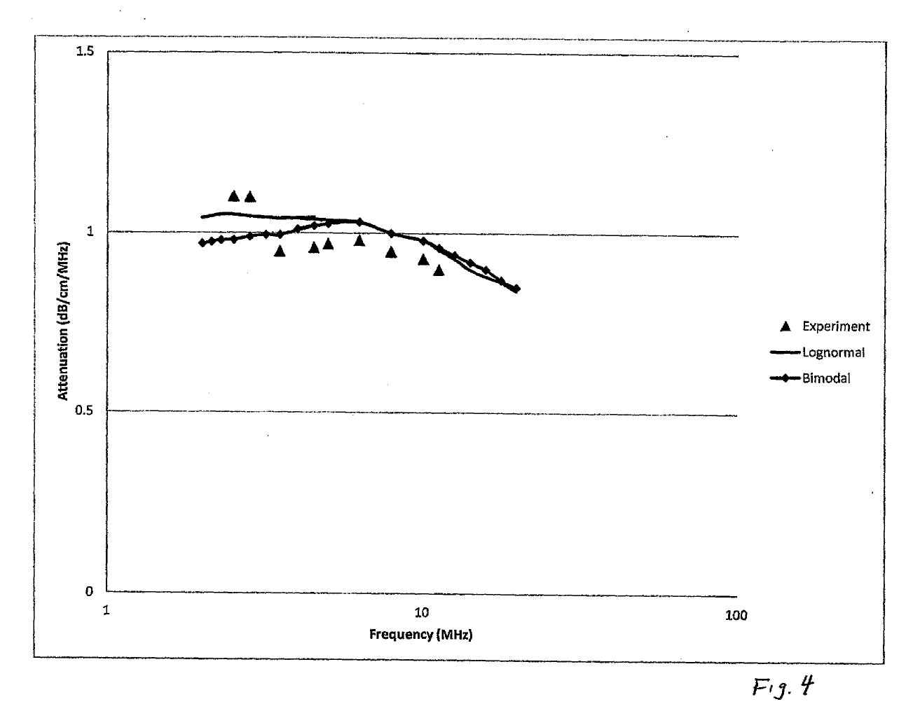

The results of the measurement are shown on FIGS. 4, 5, and 6.

FIG. 4 presents measured attenuation spectra (triangles) and theoretic attenuation spectra calculated for particle size distribution shown on FIG. 3. It is seen that theoretical attenuation fits the experimental attenuation one very well.

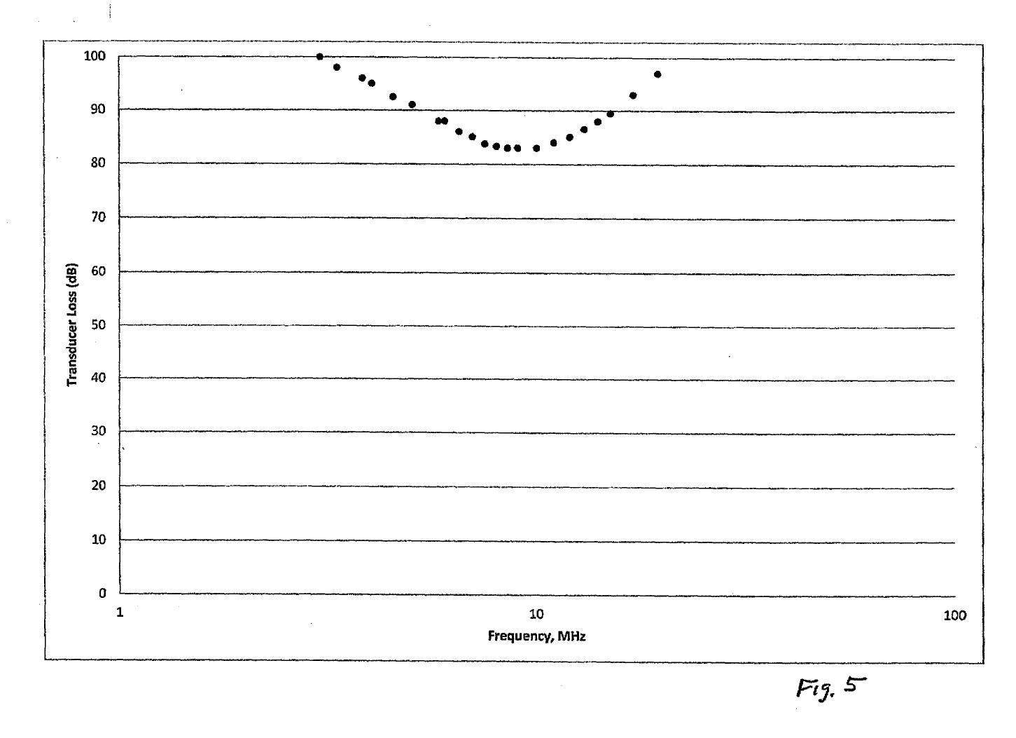

FIG. 5 presents “hardware energy loss”, which was measured at the very beginning when the gap between transmitter and receiver equals double thickness of the pipe wall 6a.

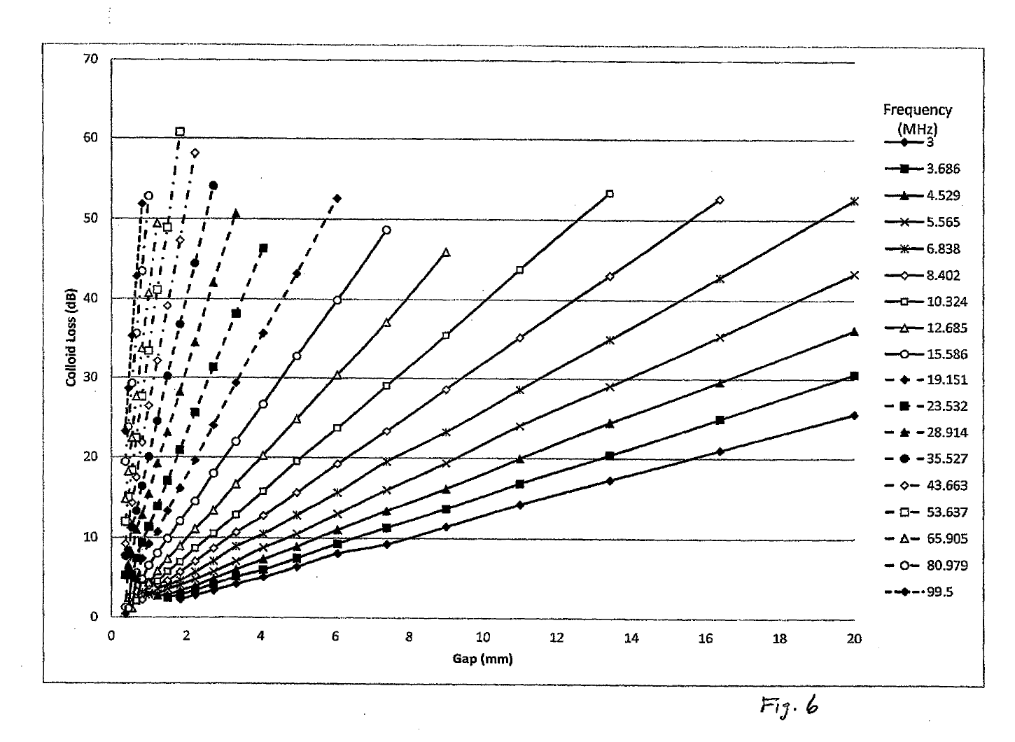

FIG. 6 illustrates Beer-Lambert law. FIG. 6 shows energy loss in the liquid after the “hardware loss” was subtracted out for different frequencies as function of the distance between the transmitter and the receiver. It must be a linear function of the gap when expressed in decibels according to the Eq. 2. FIG. 6 confirms the linearity.

The test has confirmed that the present invention can conduct ultrasound attenuation measurement of concentrated complex dispersions and emulsion through the wall of the flexible pipe 6. This is a necessary condition for conducting on-line particle size distribution measurements.

### U.S. PATENT DOCUMENTS

Hamstead, P. J. “Apparatus for determining the time taken for sound energy to cross a body of fluid in a pipe”, U.S. Pat. No. 5,359,897 (1994)
Kikuta, M. “Method and apparatus for analyzing the composition of an electro-deposition coating material and method and apparatus for controlling said composition”, U.S. Pat. No. 5,368,716 (1994)
Sowerby, B. D. “Method and apparatus for determining the particle size distribution, the solids content and the solute concentration of a suspension of solids in a solution bearing a solute”, U.S. Pat. No. 5,569,844 (1996)
Uusitalo, S. J., von Alfthan, G. C., Andersson, T. S., Paukku, V. A., Kahara, L. S. and Kiuru, E. S. “Method and apparatus for determination of the average particle size in slurry”, U.S. Pat. No. 4,412,451 (1983)
Riebel, U. “Method of and an apparatus for ultrasonic measuring of the solids concentration and particle size distribution in a suspension”, U.S. Pat. No. 4,706,509 (1987)
Alba, F. “Method and Apparatus for Determining Particle Size Distribution and Concentration in a Suspension Using Ultrasonics”, U.S. Pat. No. 5,121,629 (1992)
Dukhin, A. S. and Goetz, P. J. “Method and device for characterizing particle size distribution and zeta potential in concentrated system by means of Acoustic and Electroacoustic Spectroscopy”, U.S. Pat. No. 6,109,098 (2000)
Dukhin, A. S. and Goetz, P. J. “Method and device for Determining Particle Size Distribution and Zeta Potential in Concentrated Dispersions”, U.S. Pat. No. 6,449,563 (2002)
Erwin, L. and Dohner, J. L. “On-line measurement of fluid mixtures”, U.S. Pat. No. 4,509,360 (1985)
Carasso, M., Patel, S., Valdes, J., White, C. A. “Process for determining characteristics of suspended particles”, U.S. Pat. No. 6,119,510 (2000)
DosRamos, J. G., Reed, R. W., Oja, T., and Boulet, G., “Device for use in determining characteristics of particles dispersed in medium, and method therefore”, U.S. Pat. No. 6,604,408 (Aug. 12, 2003).
Africk, S. A., Colton, C. K. “System and method for ultrasonic measuring of particles properties”, U.S. Pat. No. 7,984,642, (Jul. 26, 2011)
Scott, D. M. “Method and apparatus for ultrasonic sizing of particles in suspensions”, U.S. Pat. No. 7,331,233, (Feb. 19, 2008).
Panneta, P. D, Pappas, R. A. and Tucker, B. J. “Process monitoring and particle characterization with ultrasonic backscattering”, U.S. Pat. No. 7,114,375, (Oct. 3, 2006)
Jen, Cheng-Knei, Nguyen, K. T., Cao, B., Wang H. “Ultrasonic sensors for on-line monitoring of castings and molding processes at elevated temperatures”, U.S. Pat. No. 5,951,163 (Sep. 14, 1999)

### OTHER PUBLICATIONS

1. International Standard 20998, Part 1 “Measurement and characterization of particles by acoustic methods”, ISO 2006
2. Dukhin A. S. and Goetz P. J in 2010 “Characterization of liquids, nano- and microparticulates and porous bodies using Ultrasound”, Elsevier, 2010
3. J. H. Lambert, Photometria sive de mensura et gradibus luminis colorum et umbrae [Photometry, or, On the measure and gradations of light, colors, and shade] (Augsburg (“Augusta Vindelicorum”), Germany: Eberhardt Klett, 1760).
4. Beer, “Bestimmung der Absorption des rothen Lichts in farbigen Flüssigkeiten” (Determination of the absorption of red light in colored liquids), Annalen der Physik and Chemie, vol. 86, pp. 78-88, (1852)

We claim:

1. A device for determining particle size distribution on-line for concentrated dispersions or emulsions, the device comprising:
an electronic block for generating electric pulses of specified frequencies on MHz scale and measuring magnitude and phase thereof;
an acoustic sensor having an ultrasound transmitter for converting the electric pulses into ultrasound pulses of a same frequency and an ultrasound receiver for converting the ultrasound pulses back into electric pulses;
said transmitter and said receiver each having a respective face;
a stepping motor connected to a movable piston carrying one of said ultrasound transmitter or said ultrasound receiver thereon;
a pipe with a flexible wall for conducting the dispersion or emulsion past the acoustic sensor, said pipe being disposed between said transmitter and said receiver, and said pipe having an exterior surface, said face of said transmitter and said face of said receiver being affixed to said exterior surface of said pipe.

2. The device according to claim 1, wherein said exterior surface of said pipe is affixed to said face of said receiver and to said face of said transmitter so that said faces and said surface do not move relative to one another during compression of said pipe.

3. A method for determining particle size distribution on-line for concentrated dispersions and emulsions, the method comprising:
providing the device according to claim 1;
driving the stepping motor to a point where a distance between the transmitter and the receiver faces equals twice a thickness of the pipe wall for defining a closed system;
subsequent to defining the closed system, transmitting pulses at the specified frequencies through the closed system for measuring a first energy loss of the transmitter, the receiver, and the pipe at each of the specified frequencies;
moving a sample through the pipe and driving the stepping motor in specified multiple increments for opening the pipe to gap positions between the transmitter and the receiver and transmitting the pulses at the specified frequencies for each of the gap positions for measuring a second energy loss at each of the specified frequencies;
for each of the specified frequencies, subtracting the first energy loss from the second energy loss at the corresponding frequencies for each of the gap positions for determining energy losses in the sample;
presenting the energy losses in the sample in decibels;
for each of the gap positions, generating measured attenuation frequency spectra by calculating measured attenuation for each of the specified frequencies as a result of linear regression of the energy loss versus a value of a corresponding gap position between the transmitter and the receiver;
determining particle size distribution as a result of best theoretical fit of the measured attenuation frequency spectra.

4. A method for determining particle size distribution on-line for concentrated dispersions and emulsions, the method comprising:
providing the device according to claim 1;
driving the stepping motor to a point where a distance between the transmitter and the receiver faces equals twice a thickness of the pipe wall for defining a closed system;
subsequent to defining the closed system, transmitting pulses at the specified frequencies through the closed system for measuring a first energy loss of the transmitter, the receiver, and the pipe at each of the specified frequencies;
moving a sample through the pipe and driving the stepping motor in specified multiple increments for opening the pipe to gap positions between the transmitter and the receiver and transmitting the pulses at the specified frequencies for each of the gap positions for measuring a second energy loss at each of the specified frequencies;
for each of the specified frequencies, subtracting the first energy loss from the second energy loss at the corresponding frequencies for each of the gap positions for determining energy losses in the sample;
defining an optimum single gap position by selecting a gap position of the gap positions that allows measurement at the widest frequency range;
driving the stepping motor for opening the transmitter and the receiver to the optimum single gap;
moving the sample through the pipe and transmitting the pulses at the specified frequencies at the optimum single gap position for measuring a third energy loss at each of the specified frequencies;
for each of the specified frequencies, subtracting the first energy loss from the third energy loss at the corresponding frequencies for the optimum single gap position for determining single optimum gap position energy loss in the sample;
presenting the single optimum gap position energy loss in the sample in decibels,
for the optimum single gap position, generating measured attenuation frequency spectra by calculating measured attenuation for each of the specified frequencies as a result of linear regression of the single optimum gap position energy loss versus a value of the optimum single gap position between the transmitter and the receiver;
determining particle size distribution as a result of best theoretical fit of the measured attenuation frequency spectra.

5. A device for determining particle size distribution on-line for concentrated dispersions or emulsions, the device comprising:
an acoustic sensor having an ultrasound transmitter for converting electric pulses into ultrasound pulses of a same frequency and an ultrasound receiver for converting the ultrasound pulses back into electric pulses; said transmitter and said receiver each having a respective face;
a pipe with a flexible wall for conducting the dispersion or emulsion past the acoustic sensor, said pipe being disposed between said transmitter and said receiver, and said pipe having an exterior surface, said face of said transmitter and said face of said receiver being affixed to said exterior surface of said pipe for compressing the pipe therebetween.

6. The device in claim 5 further comprising:
a displacing device mounted to one of said ultrasound transducer or said ultrasound receiver for displacing said flexible wall to selectable gap positions.

7. The device in claim 6 further comprising: an electronic block connected to said acoustic sensor for generating electric pulses of specified frequencies on MHz scale and measuring magnitude and phase thereof.
